(19) United States
(12) Patent Application Publication
(10) Pub. No.: US 2012/0325904 A1
(43) Pub. Date: Dec. 27, 2012

(54) Emergency Time Cash Machine

(76) Inventor: Etta Harbin, Miramar, FL (US)

(21) Appl. No.: 13/534,097

(22) Filed: Jun. 27, 2012

Related U.S. Application Data
(60) Provisional application No. 61/501,528, filed on Jun. 27, 2011.

(51) Int. Cl. G07F 19/00

(52) U.S. Cl. 235/379

(57) ABSTRACT

An apparatus for processing a cashier's check from home. A user may input account information into the apparatus that is verified with the user's fingerprint prior. Once verified, the apparatus may issue a valid cashier's check drawn on the user's account from a lending institution such as a bank, and method of using the same.

### CROSS-REFERENCE

This application claims priority from Provisional Patent Application Ser. No. 61/501,528 filed Jun. 27, 2011.

### FIELD OF THE INVENTION

This invention pertains generally to an apparatus for processing a cashier's check remotely from a bank or other financial institution, and more particularly to an apparatus for remotely printing a cashier's check after verifying a users identity with a biometric identification component and confirming the availability of funds in the users account and a method of using the same.

### BACKGROUND

Individuals who conduct business with banks, credit unions, or other financial institutions generally must travel to a branch office in order to access their money. Bank hours vary, and many times the branch office is closed when the individual needs access to their money. While automatic teller machines may be one after hours option, many people feel that they are in danger by accessing their money that way, especially after dark. In the event of an emergency, it can also be difficult for individuals to access their money. There is often a need for money late at night or early in the morning when banks are not open.

Consequently, there is a need for an easy and safe way for customers to have immediate access to their money outside of normal banking hours. The present invention discloses an apparatus for processing a cashier's check remotely. The apparatus is designed for use in an individual's residence to produce a cashier's check during hours in which the bank is closed. The apparatus provides a safe way to access one's money in an emergency situation where leaving the residence may be dangerous. The present invention also discloses a method of identifying and verifying an account user and processing a cashier's check using available funds.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an apparatus for processing a cashier's check or other similar negotiable instrument from home. The apparatus comprises a biometric processing element that enables a banking institution to confirm a user's identity. The user enters account information with a data entry element located on the apparatus to access available funds in the account. The apparatus transmits the account information to the banking institution for validation of availability of funds. The banking institution then verifies the user's identity with data received from the biometric processing element and allows the apparatus to print out the cashier's check.

Furthermore, in the preferred embodiment, the biometric element comprises a thumbprint identifier, whereby a thumbprint is scanned and electronically communicated to the banking institution for verification of the user by comparison to a thumbprint database on file. A blank cashier's check is then inserted into the apparatus. Once the user is verified and a requested monetary amount is validated as available, the thumbprint is erased and the apparatus prints out a valid cashier's check without the need for the user to go to the banking institution.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a top perspective view of an apparatus for processing a check in accordance with the disclosed architecture.

FIG. 2 illustrates a top perspective view of the apparatus for processing a check where an incomplete check is inserted into the apparatus in accordance with the disclosed architecture.

FIG. 3 illustrates a top perspective view of the apparatus for processing a check where the incomplete check is substantially within the apparatus in accordance with the disclosed architecture.

FIG. 4 illustrates a top perspective view of the apparatus for processing a check wherein the a completed check is removed from the apparatus in accordance with the disclosed architecture.

FIG. 5 illustrates a top perspective view of an apparatus for processing a check in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

Processing a cashier's check typically requires an individual to make a trip to a lending institution, such as a bank or credit union, to access funds by cashier's check. On the weekend, during holidays, and after banking hours, the individual is unable to obtain the cashier's check from the lending institution. The present invention is designed to process cashier's checks from home at anytime, regardless of whether the lending institution is open, thereby allowing the individual to have greater access to and flexibility to access available funds from their bank accounts.

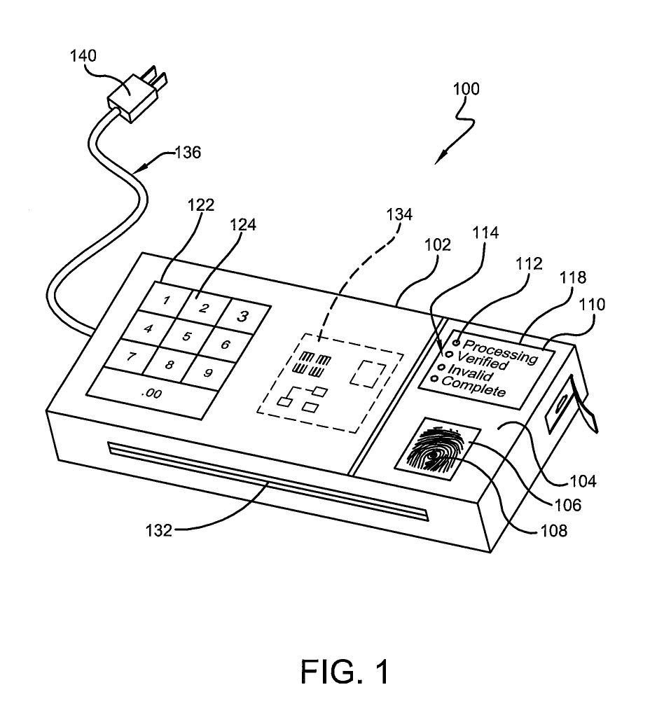

Referring initially to the drawings, FIG. 1 illustrates an apparatus 100 for processing a check without the need to physically visit a lending institution. The lending institution may comprise banks, credit unions, brokerages, and the like, or any institution capable of processing and issuing a cashier's check. While the check is preferably a cashier's check 10, the check may comprise any negotiable instrument payable on demand by a lending institution such as a bearer instrument, a banker's check, a bank cheque, an official check, a demand draft, a teller's check, a treasurer's check, a personal check, and the like.

The apparatus 100 comprises a housing unit 102. The housing unit 102 is preferably, constructed from plastic, though it is contemplated that other suitable materials known in the art could be used without affecting the overall scope of the invention. Embedded in or otherwise externally integrated with the housing unit 102 are a biometric processing element 104 and a data entry element 122. The biometric processing element 104 allows the lending institution to verify the identity of an account holder remotely. Typically, the biometric processing element 104 comprises a fingerprint identification component 106, preferably a thumbprint identification component 108; however this is not meant as a limitation any biometric identifier such as a retinal scanning element (not shown) could be used as well. The fingerprint identification component 106 typically scans the user's thumbprint and temporarily stores a digital image of the thumbprint.

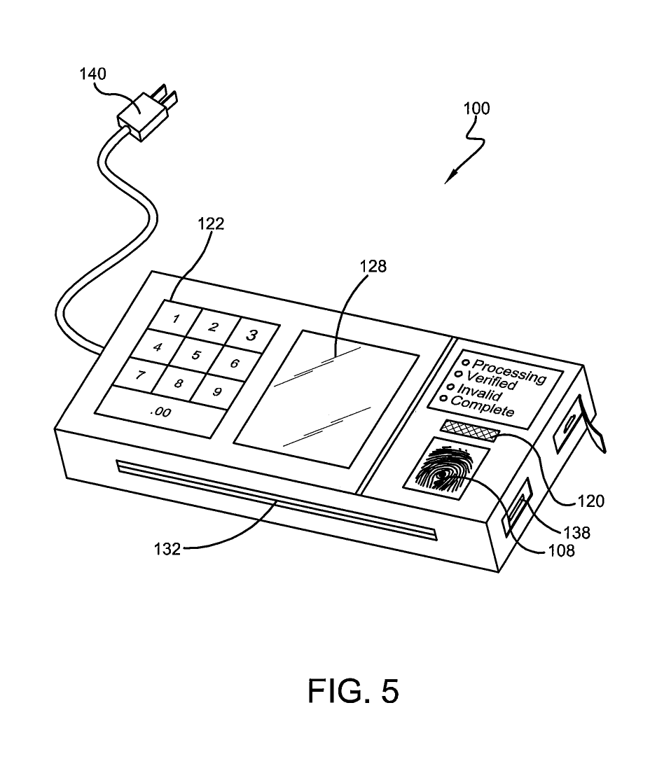

The biometric processing element 104 further comprises an authorization indicating component 110 for use in authenticating the identity of the user and authorizing a transaction from the user's account. In the preferred embodiment, the authorization indicating component 110 comprises a visual signal 112 such as a series of display lights 114. The series of display lights 114 typically correspond to a series of words 118 to indicate a status of the transaction. The series of words 118 may comprise the following words: processing, verified, invalid, and complete. A corresponding light from the series of display lights 114 would light up to display the status as the transaction progresses. For example, after the user inputs data with the data entry element 122, the corresponding light from the series of display lights 114 next to the word processing from the series of words 118 would illuminate to indicate that the transaction was currently in process. Similarly, should there be insufficient funds available in the account, the corresponding light from the series of display lights 114 next to the word invalid from the series of words 118 would light up to indicate a failed transaction. The series of display lights 114 may comprise any number of lights of any color as desired. Similarly, the series of words 118 may comprise any word desirable to indicate the status of the transaction. Additionally, as shown in FIG. 5, an audible signal 120, such as a speaker, a beep, a ring, a tone, and the like, may be included to audibly indicate the status of the transaction.

The data entry element 122 is typically a numeric keypad, but may also comprise a QWERTY keypad (not shown) or a touch screen 128 as seen in FIG. 5. The data entry element 122 permits the user to input information such as a bank account number, a personal identification number, a unique apparatus identifying number, a dollar amount, and the like.

The apparatus 100 further comprises a computer processing element 134 typically located within the housing unit 102. The computer processing element 134 is capable of encrypting, decrypting, transmitting, receiving, and storing data. Both the data entry element 122 and the biometric processing element 104 are in electronic communication with the computer processing element 134. Once the data is input, the computer processing element 134 may encrypt the data and transmit it to the appropriate location, such as the lending institution. Any modern communication means known in the art may be used to transmit the data including, but not limited to: wireless, digital, modem, landline phone line, fiber optic cable, cellular phone, and the like. Typically, the computer processing element 134 will transmit and receive data wirelessly.

The apparatus 100 further comprises a printing element 132 and a power source 136. The printing element 132 is located internally within the housing unit 102 and is capable of receiving blank check stock and the like. As cashier's checks typically use security inks, the printing element 132 is compatible with a plurality of inks including, but not limited to: thermo-chromatic inks, photo-chromatic inks, time-sensitive inks, ultraviolet inks, fluorescent inks, and the like. The power source 136 is typically a battery 138 or an electric cord 140, but may also comprise a USB cable, a printer cable, and the like.

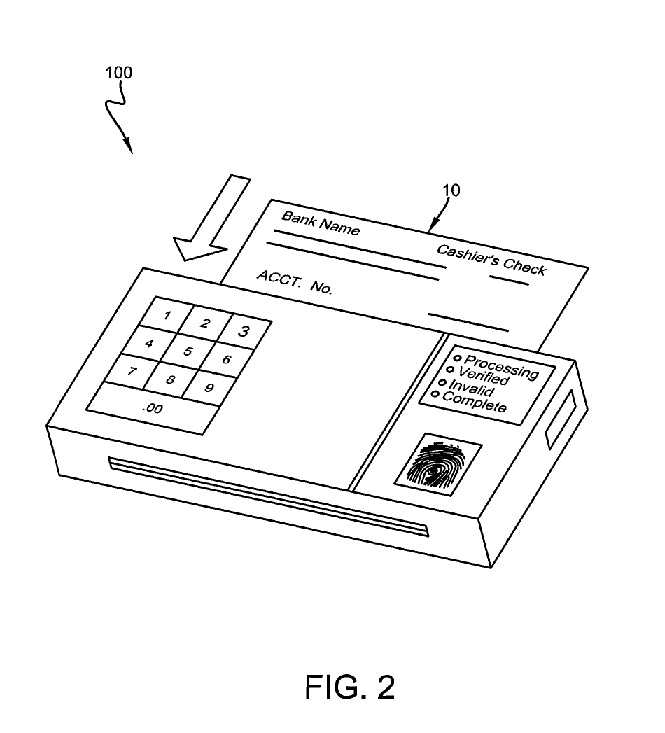

Illustrated in FIGS. 2-4, is an exemplary method of remotely printing a valid cashier's check 10. The method will be described with respect to FIGS. 1 and 5. The user would typically place a digital thumbprint or other biometric identifier on file at the lending institution and obtain the apparatus 100 for processing the cashier's check 10. The apparatus 100 would then be programmed with controlled identifying data comprising the bank account number, the personal identification number, the unique apparatus identification number, and any other information that would be useful to access the account or verify the user.

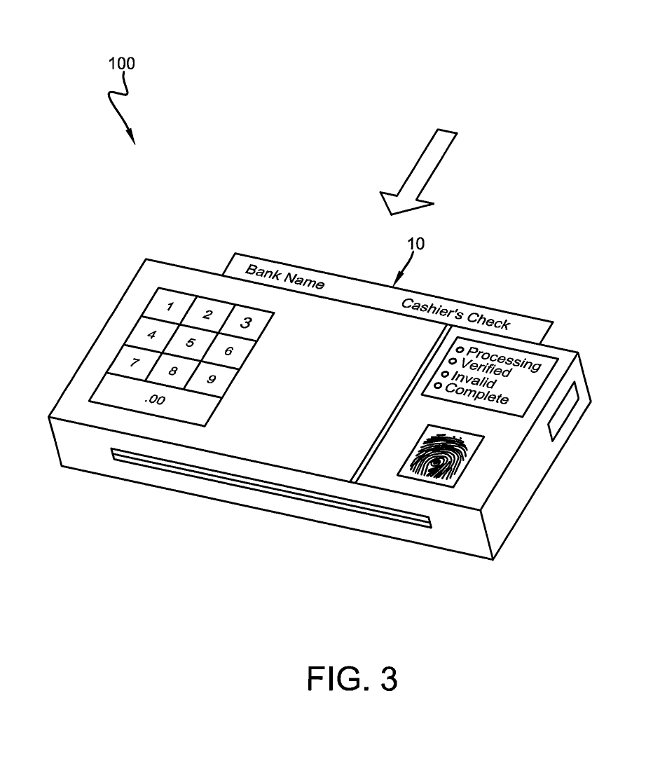

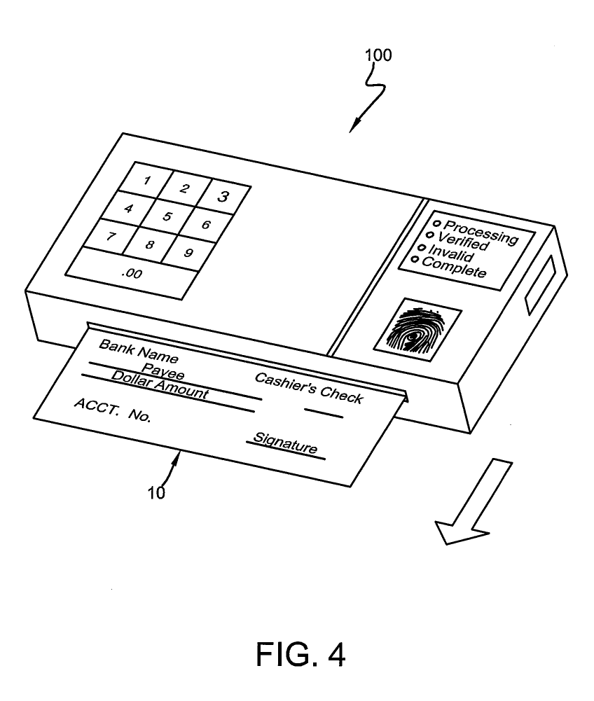

To print the cashier's check 10 with the apparatus 100, the user would enter the identifying data or information through the data entry element 122. Next, as seen in FIG. 2, the incomplete or blank cashier's check 10, such as a piece of blank or incomplete security paper stock, is inserted into the housing unit 102. The numerical currency amount and any other relevant data may then be input through the data entry element 122. Once the data is entered, in FIG. 3, the computer processing element 134 encrypts or encodes the data and transmits the data to the lending institution for validation of sufficient available funds in the account. Then the apparatus 100 may verify and biometrically confirm the identity of the account holder with the account holder's thumbprint. The user places a thumb on the biometric processing element 104 and waits for the authorizing indicating component 110 to indicate verification. Once verified, the biometric identifier data may be erased from the computer processing element 134, and at FIG. 4, a completed valid cashier's check issues from the housing unit 102.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An apparatus for processing a check, the apparatus comprising:
a housing unit;
a biometric processing element located on the housing unit comprising a fingerprint identification component and an authorization indicating component; and
a data entry element located on the housing unit;
a printing element located within the housing unit; and
a computer processing element located within the housing unit, wherein the computer processing element stores, encrypts, transmits, receives, and decrypts data.

2. The apparatus of claim 1, wherein the authorization indicating component comprises a series of display lights corresponding to a series of words that indicate a status of the check processing.

3. The apparatus of claim 2, wherein the series of words is comprised of at least one of the following words: processing, verified, invalid, and complete.

4. The apparatus of claim 1, wherein the data entry element is comprised of at least one of the following: a numeric keypad, a QWERTY keypad, or a touch screen.

5. The apparatus of claim 1, wherein the printing element is compatible with at least one of the following: thermo-chromatic inks, photo-chromatic inks, time-sensitive inks, ultra-violet inks, or fluorescent inks.

6. The apparatus of claim 1, further comprising a battery.

7. An apparatus for authenticating a user and authorizing and processing a negotiable instrument, the apparatus comprising:
a housing unit;
a biometric processing element located on the housing unit, wherein the biometric processing element comprises a thumbprint identification component and an authorization indicating component; and
a numeric keypad located on the housing unit;
a printing element located within the housing unit;
a computer processing element located within the housing unit, wherein the computer processing element stores, encrypts, transmits, receives, and decrypts data; and
a power source.

8. The apparatus of claim 7, wherein the negotiable instrument is comprised of at least one of the following: a bearer instrument, a banker's check, a bank cheque, an official check, a demand draft, a bank draft, a teller's check, a treasurer's check, or a personal check.

9. The apparatus of claim 7, wherein the negotiable instrument is a cashier's check.

10. The apparatus of claim 7, wherein the authorization indicating component comprises a visual signal and an audible signal.

11. The apparatus of claim 10, wherein the visual signal comprises a series of display lights and the audible signal is a tone.

12. The apparatus of claim 7, wherein the computer processing element transmits and receives data wirelessly.

13. The apparatus of claim 7, wherein the computer processing element transmits and receives data via a phone line, a fiber optic cable, or a land line.

14. The apparatus of claim 7, wherein the power source comprises an electric power cord.

15. A method of remotely printing a valid cashier's check, the method comprising:
obtaining an apparatus for processing a cashier's check;
identifying an account holder by entering user identifying information comprising an account number, a personal identification number, and an apparatus code;
loading an incomplete cashier's check into the apparatus;
entering a numerical currency amount;
validating the availability of funds in the account;
verifying the identity of the account holder with a biometric identifier; and
issuing the completed cashier's check.

16. The method of claim 15, wherein the apparatus code is unique to the apparatus.

17. The method of claim 15, wherein the biometric identifier is a thumb print from the account holder.

18. The method of claim 15, further comprising encoding any data transmitted by the apparatus, and decoding any data received by the apparatus.

19. The method of claim 15, further comprising erasing the biometric identifier data once the account holder's identity has been verified.

20. The method of claim 15, wherein the incomplete cashier's check comprises bank issued security paper stock.
